(19) United States
(12) Patent Application Publication
(10) Pub. No.: US 2026/0061574 A1
(43) Pub. Date: Mar. 5, 2026

(54) OFFSET GEAR UNIT

(71) Applicant: ATLAS COPCO INDUSTRIAL TECHNIQUE AB, Stockholm (SE)

(72) Inventors: Ali Kamyab, Borke Segeltorp (SE); Per Forsberg, Värmd. (SE)

(73) Assignee: ATLAS COPCO INDUSTRIAL TECHNIQUE AB, Stockholm (SE)

(21) Appl. No.: 19/298,420

(22) Filed: Aug. 13, 2025

(30) Foreign Application Priority Data
Sep. 2, 2024 (SE) 2430438-8

(51) Int. Cl. B25B 23/00; B25B 21/00

(52) U.S. Cl. CPC B25B 23/0035; B25B 21/002

(57) ABSTRACT

The present specification related to an offset gear unit for use with a power tool for tightening of threaded fasteners comprising a housing, an input gear wheel for connection to an output shaft of the power tool, an output gear wheel, and at least one intermediate gear wheel, wherein the offset gear unit further comprises a bit receiving arrangement for receiving a bit, the bit being arranged to be driven in rotation by the output wheel and wherein the bit receiving arrangement comprises a bit securing member adapted to cooperate with an abutment feature provided on the bit in order to secure the bit in the offset gear unit in an axial direction. The present specification also relates to a power tool and a kit comprising such an offset gear unit.

### TECHNICAL FIELD

The present invention generally relates to power tools for tightening of threaded fasteners, more particularly to power tool attachments such as offset gear units for use with such tools.

### BACKGROUND

Electrical power tools for tightening of threaded fasteners are known to be used in various industries. Such power tools may for example be electrically or pneumatically powered.

In some mounting applications, particularly constrains are put on the design of the tools used due to not only the use of small and short screws but also the small size of the products to be assembled. Examples of such applications comprise mounting applications in production of electronic devices.

To access tight or hard-to-reach spaces during the assembly of such small devices, where using a regular power tool is not feasible for tightening fasteners, power tool attachments parts known as offset gear units are often utilized. Such power tool attachment parts, also known as output gear extensions, typically connects to the output end of a power tool, and typically includes one or more gear wheels that transmit a rotating movement from an input gear wheel to an output gear wheel. The gear wheels are generally located, teeth against teeth, inside a housing.

As the offset gear units are generally used in small spaces in assembly of small products, the size of the offset gear unit is an important feature. This poses constraints on the design and the choice of components included with such units.

In addition, in applications in the electronics industry which commonly involve tightening of large numbers of small screws, the need for frequent bit change is common. A design allowing for fast and convenient bit change is therefore of importance as well.

Hence, there is a need for an improved offset gear unit that can solve or at least mitigate the above-mentioned problems.

### SUMMARY

Accordingly, it would be desirable to provide an offset gear unit which is more convenient to handle, particularly with regards to bit change, thus offering improved usability. In particular, it would be desirable to provide such a design in a particularly compact manner. To better address one or more of these concerns an offset gear unit, a power tool and a kit as defined in the independent claims are provided. Preferred embodiments are defined in the dependent claims.

According to a first aspect of the invention, a offset gear unit for use with a power tool for tightening of threaded fasteners is provided, the offset gear unit comprising a housing, an input gear wheel for connection to an output shaft of the power tool, which input gear wheel is arranged at a first end of the housing, an output gear wheel, which output gear wheel is arranged at a second end of the housing, and at least one intermediate gear wheel, which is arranged inside the housing to transmit rotation of the input gear wheel to the output gear wheel, wherein the offset gear unit further comprises a bit receiving arrangement for receiving a bit in the offset gear unit, the bit being arranged to be driven in rotation by the output wheel and wherein the bit receiving arrangement comprises a bit securing member adapted to cooperate with an abutment feature provided on the bit in order to secure the bit in the offset gear unit in an axial direction.

According to the first aspect, the offset gear unit provides an inventive solution to the aforementioned concerns through a design that includes a bit securing member (also referred to in the present specification as s securing member) configured to cooperate with an abutment feature on the bit, thereby securing the bit within the offset gear unit. This design achieves a straightforward and user-friendly configuration, significantly reducing the time and effort required for bit changes and enhancing overall usability.

Furthermore, the utilization of the abutment feature on the bit facilitates a particularly compact design.

The bit may be a bit adapted to engage a screw or nut. The bit receiving arrangement may be arranged at the second end of the housing and may include means, such as a bit holder, for receiving and possibly securing the bit in a rotational direction. The arrangement may further be arranged to receive the bit in a torque transmitting manner, driving the bit in rotation.

The output gear unit may for example be adapted for tightening of screws in a size of M0.2-M4, in some embodiments M0.5-M2. The output gear unit may in some embodiments be adapted for tightening of screws in a torque range of 5-15 cNm, in some embodiment 5.5-12.5 cNm.

According to one embodiment, the abutment feature BA is a groove or a ridge, shoulder or protrusion provided on the bit. The abutment feature, which may also be referred to as a matching or interfacing feature, may for example extend along the circumference of the bit. Such a groove or ridge may for example extend continuously around the full circumference of the bit or be arranged to extend along parts of the circumference (i.e. in a discontinuous manner).

The bit securing member may be adapted to cooperate with the abutment feature for example by engaging, supporting and/or allowing the abutment feature to bear against it.

According to one embodiment, the bit securing member is arranged to be movable between a first position in which the bit may be removed and a second locked position in which the bit is secured in the offset gear unit, for example at least in an axial direction.

According to one embodiment, the bit securing member is movably attached to the housing. The securing member may for example be arranged to be movable in a linear direction of movement and/or in a rotational direction of movement. In other embodiments, the securing member may be detachably attached to the housing, such that the securing member is only attached to the housing in the second position. The securing member may for example be made from steel or aluminum.

In one embodiment, the thickness of the securing member lies in the range 0-1 mm, in one embodiment in the range 0.2-0.5 m.

According to one embodiment, the bit securing member is pivotally arranged on the housing.

According to one embodiment, the bit securing member is pivotally arranged about a pivot axis (or pivot point) P provided by means of a rivet or a screw. The rivet or screw may be attached to the housing of the offset gear unit. Other means are conceivable within the scope of the present invention.

According to one embodiment, the bit securing member is an elongated securing member comprising a first opening, arranged at a first end thereof, adapted to engage an element forming a pivot axis, a second opening, arranged at a second end thereof, adapted to engage a locking element in the second position, and a third intermediate opening adapted to engage the abutment feature provided on the bit B in the second position.

According to one embodiment, the first opening is a hole. Examples include a hole adapted, e.g. having a suitable diameter, to engage and pivot around a screw or rivet (or similar) providing a pivot axis.

According to one embodiment, the intermediate opening is a notch (or cutout) provided along an edge of the securing member. The opening may for example be provided along an edge forming a long side of the elongated member. The opening may further be formed, for example by being substantially u-shaped, such that the bit may enter or be received into the opening as the securing member pivots into the second position. The opening may further be adapted such that the edge of the opening engages the abutment feature on the bit in the second position, thereby preventing axial movement of the bit.

According to one embodiment, the second opening is a notch (or cutout) provided along an edge of the bit securing member. The second opening may further be formed such that (a shaft portion of) the locking member may enter or be received into the opening as the securing member pivots into the second position, for example by being substantially u-shaped or having any other shape allowing a sufficient opening for the locking member. Such an embodiment may be advantageous in that bit change may be considerably simplified since the locking member, such as a screw, needs only to be loosened, not completely removed, in order to be able to pivot the securing member out of the second position.

According to one embodiment, the second opening is a hole. In such an embodiment, the locking element may need to be removed before moving the securing member out of position.

According to one embodiment, the locking element is a screw.

According to one embodiment, the offset gear unit comprises a neck portion through which the bit, in use, may extend, wherein the securing member is arranged on the neck portion, for example on an outer end face of the neck portion. In some embodiments, the neck portion may be integrally formed with the housing. In some embodiment, the neck portion may comprise a grease nipple.

According to a second aspect of the invention, a power tool for tightening a threaded fasteners is provided, the power tool comprising an offset gear unit according to any one of the embodiments described in the foregoing. The power tool may for example comprise a motor, a tool output drivingly connected to the motor and a tool housing that at least partly houses the motor and the output.

In some embodiments, the power tool may be a fixtured tool. The tool may be an electrically or pneumatically powered tool.

According to a third aspect of the invention, a kit comprising a power tool and an offset gear unit according to any one of the embodiments described in the foregoing is provided.

Objectives, advantages and features conceivable within the scope of the second and third aspects of the invention are readily understood by the foregoing discussion referring to the first and second aspect of the invention.

Further objectives of, features of and advantages of the present invention will also become apparent when studying the following detailed disclosure, the drawings and the appended claims. Those skilled in the art realize that different features of the present invention can be combined to create embodiments other than those described in the following.

### BRIEF DESCRIPTION OF THE DRAWING

The invention will be described in the following illustrative and non-limiting detailed description of exemplary embodiments, with reference to the appended drawing, on which

FIG. 1a is a perspective view of an offset gear unit according to one embodiment.

FIG. 1b is a perspective cross sectional view of an offset gear unit according to one embodiment.

FIG. 2a is a perspective view of a front end of an offset gear unit according to one embodiment.

FIG. 2b is a perspective view of a front end of an offset gear unit according to one embodiment.

FIG. 3a is a perspective view of a front end of an offset gear unit according to one embodiment.

FIG. 3b is a perspective view of a front end of an offset gear unit according to one embodiment.

All figures are schematic, not necessarily to scale and generally only show parts which are necessary in order to elucidate the invention, wherein other parts may be omitted or merely suggested.

### DETAILED DESCRIPTION

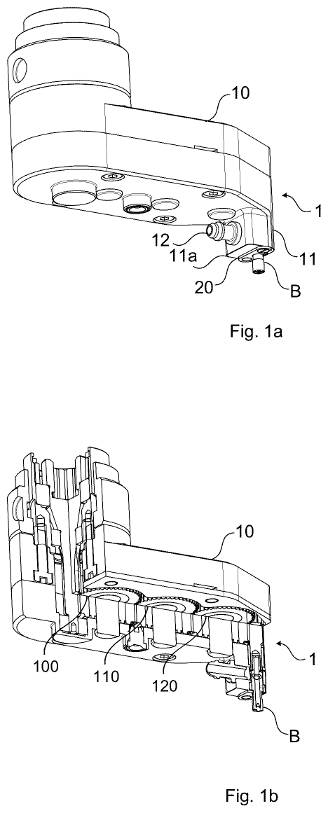

An offset gear unit 1 for tightening a threaded fastener is shown in a perspective view and a perspective cross sectional view in FIGS. 1a and b.

The offset gear unit 1 comprises a housing 10 in which an input gear wheel 100 for connection to an output shaft of a power tool, an output gear wheel 120 and an intermediate gear wheel 110 arranged to transmit rotation of the input gear wheel 100 to the output gear wheel 120 are arranged.

The offset gear unit 1 further comprises a bit receiving arrangement for receiving a bit B in the offset gear unit, the bit B being arranged to be driven in rotation by the output wheel to engage and tighten a screw or nut (or other threaded fastener).

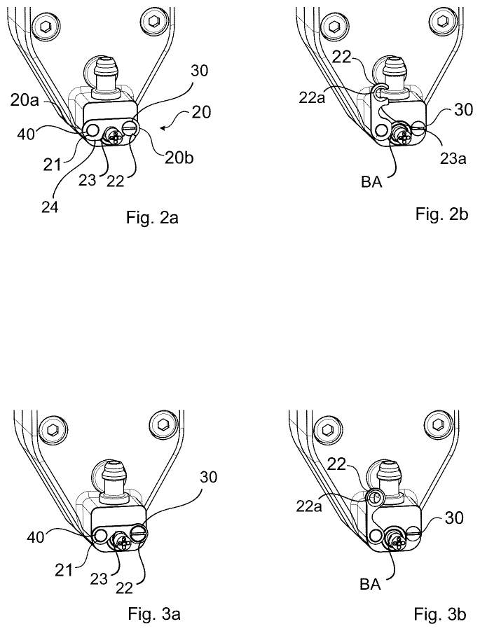

In order to secure the bit B in the offset gear unit 1 in an axial direction, the offset gear unit 1 comprises a bit securing member 20. The bit securing member 20 is adapted to cooperate with an abutment feature provided on an outer surface of the bit B, such as a groove, ridge or shoulder BA (illustrated in FIGS. 2b and 3b) on the bit B.

The offset gear unit 1, e.g. the housing 10 of the unit 1, may further comprises a neck portion 11 through which the bit B, in use, may extend.

The bit securing member 20 may for example be arranged on an outer end face 11a of this neck portion 11. The neck portion 11 may e.g. be integrally formed with the housing 10 and may further comprise a grease nipple 12.

As illustrated for example in FIGS. 2a and b, showing the front end of the offset gear unit in detail, the securing member 20 may be arranged to be movable between a first position in which bit B may be removed (shown in FIG. 2b) and a second locked position (FIG. 2a) in which bit B is secured in the offset gear unit 1.

To this end, the securing member 20 may be movably attached to the housing 10, the securing member 20 may for example be pivotally arranged on the housing such as pivotally arranged about a pivot axis provided by means of for example a rivet 40 as exemplified in FIGS. 2a and b.

The bit securing member 20 may further be an elongated securing member 20 and may be made for example from steel. The thickness of the exemplary securing member 20 shown in FIGS. 2a and b is approximately 0.4 mm.

The securing member 20 may comprise one or more openings, such as holes or cut-outs, adapted to provide the functionality of selectively locking the bit B in the unit 1 by engaging the abutment feature BA on the bit B.

The element 20 may for example comprise a first, second and a third opening 21-23. The first opening 21, e.g. a hole 21, may be arranged at a first end 20a of the securing member and be adapted to engage an element 40, e.g. a rivet 40, forming a pivot axis.

The intermediate opening 23, e.g. a notch or cut-out 23, may be adapted to engage the abutment feature BA provided on the bit B in the second position. This cut-out or notch 23 may for example be provided along an edge 24 forming a long side of the elongated member 20. The cut-out may further be formed, for example by being substantially u-shaped, such that the bit B may enter or be received into the opening 23 as the securing member pivots into the second position as may be seen from FIG. 2b. To allow the securing member 20 to pivot into position, the shape of the opening 23 may further be slightly asymmetric as may also be seen in FIGS. 2a and b. The opening 23 may further be adapted such that the edge 23a of the opening 23 engages the abutment feature BA on the bit B in the second position, thereby preventing axial movement of the bit B.

The second opening 22, e.g. a notch or cut-out 22, may be arranged at a second end 20b of the element 20 and be adapted to engage a locking element 30, such as a screw 30, in the second position. The second opening 22 may further be formed, for example by being substantially u-shaped, such that a shaft portion of the locking member 30, e.g. screw 30, may enter or be received into the opening 22 as the securing member 20 pivots into the second position (shown in FIG. 2b). The opening 22 may sometimes be formed as a circular hole having an opening (i.e. being open) along a portion of the circumference. Hereby, bit change may be considerably simplified since the locking member (screw) 30, needs only to be loosened, not completely removed, in order to be able to pivot the securing member 20 out of the second position and into the first position (shown in FIG. 2a) thereby allowing the bit B to me removed/changed. The opening 22 may further be adapted such that the edge 22a of the opening 22 engages the locking member 30, the edge 22a may for example form part of a countersink for a screw head.

FIGS. 3a and b show the front end of an alternative embodiment of the offset gear unit 1 in a perspective view, in the closed and open position respectively. The offset gear unit 1 comprises an elongated securing member 20 having a first, a second and a third opening 21-23 where the second opening 22 adapted to engage a locking element 30, such as a screw 30, is a hole 22. In such an embodiment, the screw 30 needs to be removed before moving the securing member 20 out of position in order to remove the bit B. The hole 22 may further comprise an edge 22a, for example forming part of a countersink for a screw head.

While the invention has been illustrated and described in detail in the drawings and foregoing description, such illustration and description are to be considered illustrative or exemplary and not restrictive; the invention is not limited to the disclosed embodiment. The skilled person understands that many modifications, variations and alterations are conceivable within the scope as defined in the appended claims. Additionally, variations to the disclosed embodiments can be understood and effected by those skilled in the art in practicing the claimed invention, from a study of the drawings, the disclosure and the appended claims. In the claims, the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

1. An offset gear unit for use with a power tool for tightening of threaded fasteners comprising:
a housing;
an input gear wheel for connection to an output shaft of the power tool, which input gear wheel is arranged at a first end of the housing;
an output gear wheel, which output gear wheel is arranged at a second end of the housing;
at least one intermediate gear wheel, which is arranged inside the housing to transmit rotation of the input gear wheel to the output gear wheel; and
a bit receiving arrangement for receiving a bit in said offset gear unit, said bit being arranged to be driven in rotation by said output wheel, wherein said bit receiving arrangement comprises a bit securing member adapted to cooperate with an abutment feature provided on said bit in order to secure said bit in said offset gear unit in an axial direction, wherein said bit securing member is pivotally arranged on said housing, and wherein said bit securing member is an elongated securing member comprising:
a first opening, arranged at a first end thereof, adapted to engage an element forming a pivot axis;
a second opening, arranged at a second end thereof, adapted to engage a locking element in said second position; and
a third intermediate opening adapted to engage said abutment feature provided on said bit in said second position.

2. An offset gear unit according to claim 1, wherein said abutment feature is a groove or a ridge/shoulder provided on the bit.

3. An offset gear unit according to claim 1, wherein said bit securing member is arranged to be movable between a first position in which the bit may be removed and a second locked position in which the bit is secured in said offset gear unit.

4. An offset gear unit according to claim 1, wherein said bit securing member is movably attached to said housing.

5. An offset gear unit according to claim 1, wherein said bit securing member is pivotally arranged about a pivot axis provided by means of a rivet or a screw.

6. An offset gear unit according to claim 1, wherein said first opening is a hole.

7. An offset gear unit according to claim 1, wherein said third intermediate opening is a notch/cutout provided along an edge of said securing member.

8. An offset gear unit according to claim 1, wherein said second opening is a notch/cutout provided along an edge of said securing member.

9. An offset gear unit according to claim 1, wherein said second opening is a hole.

10. An offset gear unit according to claim 1, where said locking element is a screw.

11. An offset gear unit according to claim 1 further comprising a neck portion through which said bit, in use, may extend, and wherein said securing member is arranged on said neck portion.

12. A power tool for tightening a threaded fastener, comprising an offset gear unit according to claim 1.

13. (canceled)

14. A power tool according to claim 12, wherein said abutment feature is a groove or a ridge/shoulder provided on the bit.

15. A power tool according to claim 12, wherein said bit securing member is arranged to be movable between a first position in which the bit may be removed and a second locked position in which the bit is secured in said offset gear unit.

16. A power tool according to claim 12, wherein said bit securing member is movably attached to said housing.

17. A power tool according to claim 12, wherein said bit securing member is pivotally arranged about a pivot axis provided by means of a rivet or a screw.

18. A power tool according to claim 12, wherein said first opening is a hole.

19. A power tool according to claim 12, wherein said third intermediate opening is a notch/cutout provided along an edge of said securing member.

20. A power tool according to claim 12, wherein said second opening is a notch/cutout provided along an edge of said securing member.

21. A kit comprising:
a power tool; and
an offset gear unit according to claim 1.
